(19) United States
(12) Patent Application Publication
(10) Pub. No.: US 2026/0237684 A1
(43) Pub. Date: Aug. 13, 2026

(54) COLLECTOR FOR BIPOLAR SECONDARY BATTERY AND BIPOLAR SECONDARY BATTERY

(71) Applicant: TOYOTA JIDOSHA KABUSHIKI KAISHA, Toyota-shi (JP)

(72) Inventors: Tomoyuki UEZONO, Okazaki-shi (JP); Hiroyuki YAMAGUCHI, Toyota-shi (JP); Keisuke OMORI, Kariya-shi (JP); Nariaki MIKI, Okazaki-shi (JP); Noriyuki WADA, Toyota-shi (JP)

(73) Assignee: TOYOTA JIDOSHA KABUSHIKI KAISHA, Toyota-shi (JP)

(21) Appl. No.: 19/424,672

(22) Filed: Dec. 18, 2025

(30) Foreign Application Priority Data
Feb. 12, 2025 (JP) 2025-020859

(51) Int. Cl. H01M 4/66; H01M 4/02

(52) U.S. Cl. CPC H01M 4/668; H01M 4/661; H01M 4/663; H01M 4/667; H01M 2004/021; H01M 2004/029

(57) ABSTRACT

A collector for a bipolar secondary battery includes a conductive filler and a resin binder, in which the conductive filler has at least one form selected from the group consisting of a spike-shaped form, a structure-shaped form, and a sphere-shaped form, and has a D₉₀ of 1.7 times or more and less than 5.2 times a thickness of a matrix that disperses and holds the conductive filler in the collector.

### CROSS-REFERENCE TO RELATED APPLICATION

This application claims priority to Japanese Patent Application No. 2025-020859 filed on Feb. 12, 2025. The disclosure of the above-identified application, including the specification, drawings, and claims, is incorporated by reference herein in its entirety.

### BACKGROUND

### 1. Technical Field

The present specification relates to a collector for a bipolar secondary battery, a bipolar secondary battery, and the like.

### 2. Description of Related Art

As a collector for a secondary battery such as a lithium ion secondary battery, a resin-containing collector including conductive particles and a resin binder may be used. For example, a technique has been disclosed in which a particle diameter of the conductive particles is set to 0.5 times to 2 times a thickness of the collector, and a thickness of the resin-containing collector is set to 1 μm to 500 μm, to reduce conductivity in an in-plane direction (Japanese Unexamined Patent Application Publication No. 2012-150896 (JP 2012-150896 A)).

### SUMMARY

However, in a case where the particle diameter of the conductive particles is too small, the conductive particles may be buried in the collector, and a conductive path may not be sufficiently secured. In addition, even though the particle diameter is twice a thickness of a collector layer, since there is a distribution in the particle diameter, a sufficient conductive path cannot be secured by the conductive filler that penetrates the collector. On the other hand, in a case where the conductive particles are too large, pinholes may occur in the collector.

The present specification provides a collector for a bipolar secondary battery and a bipolar secondary battery in which a conductive path can be more reliably provided and pinhole defects are reduced.

According to the present specification, a collector for a bipolar secondary battery is provided.

The collector includes
a conductive resin layer including
a conductive filler and
a resin binder.

The conductive filler has at least one form selected from the group consisting of a spike-shaped form, a structure-shaped form, and a sphere-shaped form, and has D₉₀ with 1.7 times or more and less than 5.2 times a thickness of a matrix that disperses and holds the conductive filler in the conductive resin layer.

In addition, according to the present specification, a bipolar secondary battery including a bipolar electrode including the collector is provided.

In the collector, the conductive filler has D₉₀ and a filler form that are predetermined. Therefore, the conductive filler reliably penetrates the conductive resin layer and protrudes beyond the thickness of the matrix of the conductive resin layer. As a result, a conductive path in a thickness direction of the conductive resin layer and the collector can be secured. Therefore, low resistance in the thickness direction of the collector can be achieved. In addition, occurrence of pinholes in the conductive resin layer can also be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a bipolar secondary battery;

FIG. 2 is a diagram illustrating an outline of a collector;

FIG. 3 is a diagram illustrating an example of a collector;

FIG. 4A is a diagram illustrating a microscope photograph of Ni powder (sample 1) having a spike-shaped form used in Embodiments;

FIG. 4B is a diagram illustrating a microscope photograph of Ni powder (sample 2) having a structure-shaped form used in Embodiments;

FIG. 5A is a diagram illustrating an evaluation cell (sample and comparative example sample) in Embodiments; and

FIG. 5B is a diagram illustrating an evaluation cell (control example) in Embodiments.

### DETAILED DESCRIPTION OF EMBODIMENTS

The present specification relates to a collector for a bipolar secondary battery and a bipolar secondary battery. Here, one aspect of the collector includes a conductive resin layer including a conductive filler and a resin binder. The conductive filler can have at least one form selected from the group consisting of a spike-shaped form, a structure-shaped form, and a sphere-shaped form, and have a D₉₀ of 1.7 times or more and less than 5.2 times a thickness of a matrix that disperses and holds the conductive filler in the conductive resin layer.

Another aspect of the collector, the conductive filler may have a D₉₀ of 2.0 times or more and less than 5.2 times the thickness of the matrix.

Another aspect of the collector, the thickness of the matrix may be 8 μm or more and 25 μm or less.

Another aspect of the collector, the D₉₀ of the conductive filler may be 16 μm or more and 75 μm or less.

Another aspect of the collector, the conductive filler may have a spike-shaped form or a structure-shaped form.

The bipolar secondary battery disclosed in the present specification is not particularly limited, but may be, for example, a lithium ion bipolar secondary battery, and may be a solid battery. In addition, the bipolar secondary battery is not particularly limited, but may be used, for example, for vehicle mounting.

In addition, in the present specification, in a case where a numerical value is indicated and “or more” and “or less” are used, the concepts of “or more” and “more than” and the concepts of “or less” and “less than” are included, respectively. In a case where a predetermined numerical value is defined as a critical value, a useful numerical range can be provided even in a case where the numerical value is equal to or more than the numerical value or more than the numerical value. Similarly, a useful numerical range can be provided even in a case where the numerical value is equal to or less than the numerical value or less than the numerical value.

In addition, in a case where the secondary battery is a bipolar type, the cell shape is not particularly limited. The bipolar secondary battery is a battery in which a cell in which a bipolar electrode in which a positive electrode active material layer is provided on one surface of a collector and a negative electrode active material layer is provided on the other surface is laminated in series a plurality of times with a separator including an electrolyte interposed therebetween is laminated.

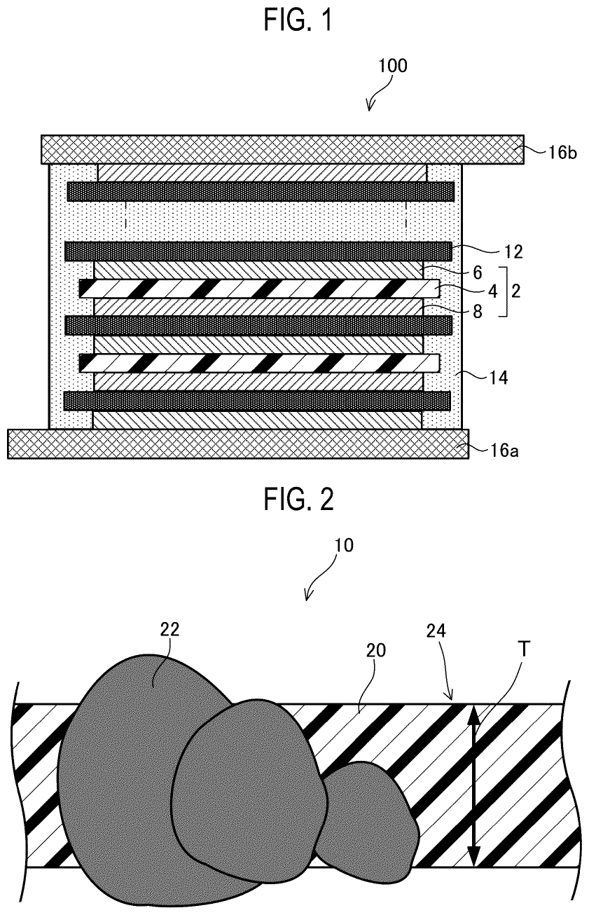

Hereinafter, the collector (hereinafter, simply referred to as a collector) 4 of the bipolar secondary battery disclosed in the present specification, the secondary battery 100, and the like will be described in detail. FIG. 1 shows a cross section of the secondary battery 100, and FIG. 2 shows an enlarged cross-sectional structure of the collector 4.

As shown in FIG. 1, the secondary battery 100 is configured by laminating a plurality of bipolar electrodes 2 through a separator 12. The negative electrode active material layer 6 and the positive electrode active material layer 8 are fixed to the collector 4 to constitute the bipolar electrode 2. End parts of the secondary battery 100 are provided with end part collectors 16a, 16b that are connected to the outside. In addition, an outer peripheral side of the secondary battery 100 is insulated by an insulating sealing material 14. As the insulating sealing material, a known insulating sealing material can be used.

### Collector and Conductive Resin Layer

As shown in FIG. 2, the collector 4 includes a conductive resin layer 10 containing a resin binder 20 and a conductive filler 22. The conductive resin layer 10 is a film-like body. The resin binder 20 constitutes a matrix (hereinafter, simply referred to as a matrix) 24 of the conductive resin layer 10. The conductive filler 22 is dispersed and held in the matrix 24.

The matrix 24 can appropriately contain other components such as a dispersant, a crosslinking accelerator, and a plasticizer in addition to the resin binder 20. From the viewpoint of electrical stability, the total content of the other components is preferably 0.001% by mass or more and 5% by mass or less, and more preferably 0.001% by mass or more and 3% by mass or less with respect to the total mass of the conductive resin layer 10.

### Resin Binder

The resin binder 20 is not particularly limited, and various resins can be used. Examples thereof include known thermoplastic resins such as olefin-based resins such as polyethylene, polypropylene, and polymethylpentene, acrylic resins such as poly(meth)acrylic acid and poly(meth)acrylic acid methyl, fluororesins such as polytetrafluoroethylene, and halogenated vinyl resins; thermosetting resins such as epoxy resins, vinyl ester resins, unsaturated polyester resins, phenol resins, and melamine resins; and known conductive polymers such as polyaniline, polypyrrole, polythiophene, polyacetylene, polyparaphenylene, polyphenylene vinylene, polyacrylonitrile, and polyoxadiazole. The resins may be used alone or in combination of two or more kinds thereof. The resin that is not conductive is preferably used for providing a conductive path in the thickness direction by the conductive filler, but the present disclosure is not particularly limited thereto. From the viewpoint of electrical stability, the resin is an olefin-based resin such as polyethylene, polypropylene, and polymethylpentene. In addition, an acrylic resin may be preferably used.

### Conductive Filler

Examples of the conductive filler 22 include metal materials or alloy materials such as nickel, aluminum, stainless steel, platinum, gold, silver, copper, and titanium; carbon materials such as graphite, carbon black (acetylene black, furnace black, Ketjen black (registered trademark)), carbon nanotubes, carbon nanofibers, carbon nanohorns, diamond-like carbon, and glassy carbon; and metal compound materials such as metal carbides, metal nitrides, and metal oxides. These may be used alone or in combination of two or more kinds thereof. For example, in the collector 4, a metal material such as nickel or a nickel alloy may be effective from the viewpoint of conductivity.

The shape of the conductive filler 22 is not particularly limited, and various forms can be adopted. For example, a form such as a spike-shaped form, a structure-shaped form, a sphere-shaped form, and a needle-shaped form can be adopted. The spike-shaped form has a large number of protrusions having a spiky shape on the surface continuously or aggregated. In addition, the particles having a spike-shaped form generally have an irregular shape to a sphere-shaped form as a whole. The particles having a spike-shaped form and containing nickel as a main component can be commercially obtained, for example, as Type 123 of Vale Co., Ltd.

The structure-shaped form refers to a structure in which a plurality of primary particles is fused and connected. Examples of the structure by the connection of the primary particles include a filament-shaped form (chain shape) and a grape-shaped form. The particles having a structure-shaped form (filament-shaped form or the like) and containing nickel as a main component can be commercially obtained, for example, from Vale Co., Ltd.

From the viewpoint of providing a conductive path in the thickness direction of the conductive resin layer 10, the conductive filler 22 preferably has a form other than a scale-shaped form. That is, a part of the conductive filler 22 may have a scale-shaped form, but the main particle shape is preferably other than a scale-shaped form. In a case of the scale-shaped form, the conductive resin layer 10 tends to have a penetrating form.

It may be preferable that the conductive filler 22 have a spike-shaped form, a structure-shaped form, and a sphere-shaped form. In a case where the conductive filler 22 has a spike-shaped form, the conductive filler 22 easily penetrates the conductive resin layer 10 in the thickness T direction in order to have an irregular shape to a sphere-shaped form, and has many contact points of the conductive path due to the protrusions. In a case of the structure-shaped form, the conductive filler 22 tends to have a filament shape or the like as a whole, and thus is preferable in that the conductive filler 22 easily penetrates the conductive resin layer 10. In addition, in a case of the sphere-shaped form, the conductive filler 22 is preferable in that the conductive filler 22 easily penetrates the conductive resin layer 10 and the area exposed on the surface of the conductive resin layer 10 is large. The particle diameter of the conductive filler 22 will be described below.

### D₉₀ of Conductive Filler

The conductive filler 22 can have a D₉₀ (μm) in which a ratio X to the thickness T (μm) of the matrix 24 is 1.7 times or more and less than 5.2 times. In a case where the ratio X of the D₉₀ to the thickness T of the matrix 24 is less than 1.7 times, the conductive resin layer 10 is less likely to be penetrated in the thickness direction of the conductive resin layer 10, and the resistance in the thickness direction is likely to increase. In addition, in a case where the ratio X is 5.2 times or more, the frequency of occurrence of pinholes increases, and the conductive resin layer 10 is likely to be discontinuous. Therefore, by setting the ratio X in this range, the resistance in the thickness direction of the secondary battery 100 can be reduced while the frequency of occurrence of pinholes is reduced.

The ratio X is, for example, 2.0 times or more, 2.1 times or more, 2.5 times or more, and 2.8 times or more. The ratio X is, for example, 5.1 times or less, 5.0 times or less, 4.0 times or less, 3.8 times or less, and 3.0 times or less. The range of the ratio X can be set to a range of 1.7 times or more and less than 5.2 times, and the lower limit and the upper limit can be appropriately combined in addition thereto. The range of the ratio X can be, for example, 2.0 times or more and 5.1 times or less, 2.0 times or more and 5.0 times or less, 2.0 times or more and 4.0 times or less, 2.0 times or more and 3.0 times or less, 2.1 times or more and 5.0 times or less, 2.1 times or more and 4.0 times or less, and 2.1 times or more and 3.8 times or less.

As described above, the conductive filler 22 preferably has a spike-shaped form, a structure-shaped form (filament shape or the like), and a sphere-shaped form. Among these, in a case of the spike-shaped form, the resistance in the thickness direction can be reduced without increasing the ratio X. Therefore, the frequency of occurrence of pinholes can be effectively reduced. In addition, in a case of the structure-shaped form, the resistance in the thickness direction can be reduced due to the form. In a case where the conductive filler 22 has a spike-shaped form, the ratio X may be 2.0 times or more and 5.0 times or less, 2.0 times or more and 4.0 times or less, 2.0 times or more and 3.0 times or less, and 2.0 times or more and 2.5 times or less. In a case of the structure-shaped form, the ratio X may be 2.0 times or more and 4.0 times or less, and 2.0 times or more and 3.0 times or less.

The D₉₀ of the conductive filler 22 is a particle diameter at which a proportion of particles having a particle diameter of D₉₀ or less is 90% in a particle size distribution on a volume basis. The D₉₀ can be measured using a laser diffraction/scattering type particle size distribution measuring device.

The D₉₀ of the conductive filler 22 is not particularly limited, but can be, for example, 16 μm or more and 75 μm or less, 16 μm or more and 60 μm or less, 16 μm or more and 45 μm or less, and 16 μm or more and 30 μm or less.

The thickness T of the matrix 24 is a thickness of the matrix 24 itself including no protrusions based on the conductive filler 22 in the conductive resin layer 10. The thickness T is an average value of thicknesses measured at 10 points by observing a cross section cut in the thickness direction of the conductive resin layer 10 using a scanning electron microscope (SEM) with an energy dispersive X-ray spectrometer (EDX). The 10 points are any points at which the conductive filler 22 is not observed, the points consisting of only the matrix 24 that disperses and holds the conductive filler 22.

The thickness T of the matrix 24 of the conductive resin layer 10 is not particularly limited, but is, for example, 1 μm or more and 100 μm or less in consideration of the D₉₀ of the conductive filler 22. The thickness T is, for example, 3 μm or more, 5 μm or more, 6 μm or more, 7 μm or more, and 8 μm or more. The thickness T is, for example, 80 μm or less, 60 μm or less, 40 μm or less, 30 μm or less, 25 μm or less, 20 μm or less, and 15 μm or less. The range of the thickness T of the matrix 24 can be set to a range of 1 μm or more and 100 μm or less, and the lower limit and the upper limit can be appropriately combined in addition thereto. For example, the range is 8 μm or more and 25 μm or less, 8 μm or more and 20 μm or less, and 8 μm or more and 15 μm or less.

The content of the conductive filler 22 and the resin binder 20 in the conductive resin layer 10 is not particularly limited. For example, the conductive filler 22 is 5% by mass or more (the resin binder 20 is 95% by mass or less), 10% by mass or more, 15% by mass or more, 20% by mass or more, and 25% by mass or more with respect to the total mass of the conductive filler 22 and the resin binder 20. The conductive filler 22 is, for example, 40% by mass or less, 35% by mass or less, and 30% by mass or less. The range of the content of the conductive filler 22 can be set by appropriately combining the lower limit and the upper limit thereof. For example, 5% by mass or more and 15% by mass or less, 6% by mass or more and 14% by mass or less, and 8% by mass or more and 12% by mass or less. The total mass of the conductive filler 22 and the resin binder 20 with respect to the total mass of the conductive resin layer 10 is not particularly limited, but is 95% by mass or more and 100% by mass or less, 97% by mass or more and 100% by mass or less, 98% by mass or more and 100% by mass or less, and 99% by mass or more and 100% by mass or less.

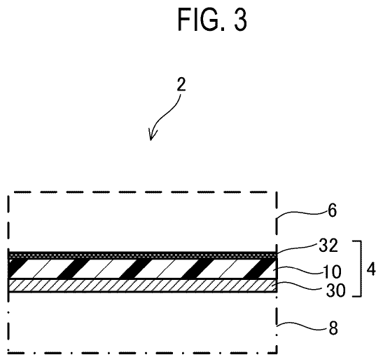

The collector 4 can have only the conductive resin layer 10. In addition, as shown in FIG. 3, the collector 4 may include the conductive resin layer 10 and a metal layer 30 on at least one surface of the conductive resin layer 10. In the example shown in FIG. 3, the conductive resin layer 10 is used as a collector layer on the negative electrode side. In this case, the metal layer 30 can be provided on a surface of the conductive resin layer 10 facing the positive electrode active material layer 8. As the metal layer 30, a known metal can be used as a collector on the positive electrode side. The metal layer 30 includes, for example, aluminum, and is typically an aluminum or aluminum alloy foil. Although not shown, in a case where the conductive resin layer 10 is used as a collector layer on the positive electrode side, the metal layer 30 can be provided on a surface of the conductive resin layer 10 facing the negative electrode active material layer 6. In this case, as the metal layer 30, a known metal can be used as a collector on the negative electrode side. The metal layer 30 includes, for example, copper or nickel, and is typically a copper foil or a nickel foil. The thickness of the metal layer 30 as the metal foil is not particularly limited, but is, for example, 5 μm or more and 100 μm or less, and 20 μm or more and 40 μm or less.

The metal layer 30 may be a metal layer 30 obtained by a film forming method such as physical vapor deposition (vacuum vapor deposition, ion plating, sputtering, and the like), chemical vapor deposition, and plating. In a case of the metal layer 30 by physical vapor deposition or the like, the thickness of the metal layer 30 is not particularly limited, but can be, for example, 5 nm or more and 200 nm or less.

The collector 4 may include a carbon coating layer 32 between the negative electrode active material layer 6 and/or the positive electrode active material layer 8, in addition to the conductive resin layer 10, as necessary. The carbon coating layer 32 includes a carbon material such as acetylene black, carbon black, and graphite, having electron conductivity. The carbon coating layer 32 can improve the adhesiveness between the collector 4 and the active material layers 6, 8. The carbon coating layer 32 is provided to be in contact with the active material layers 6, 8. In a case where the collector 4 includes the metal layer 30, the carbon coating layer 32 is provided on a surface of the metal layer 30 facing the active material layers 6, 8. In the carbon coating layer 32, the carbon material is a main component, and the resin such as the resin binder described above binds the carbon materials to each other. The thickness of the carbon coating layer 32 is, for example, 0.1 μm or more and 5 μm or less.

### Method for Manufacturing Collector

A method for manufacturing the collector 4 disclosed in the present specification includes preparing a conductive resin composition containing the conductive filler 22 and the resin binder 20, and molding a conductive resin layer 10 having a film-like shape using the conductive resin composition.

In this manufacturing method, the conductive filler 22 has a D₉₀ value in which a ratio X of the thickness T of the matrix 24 of the conductive resin layer 10 in the collector 4 to be manufactured is 1.7 times or more and less than 5.2 times. With the method, the collector 4 for a bipolar secondary battery in which the resistance in the thickness direction of the conductive resin layer 10 and the collector 4 is maintained low can be obtained. Various aspects of the conductive resin layer 10 can be appropriately applied to the resin binder 20, the conductive filler 22, the thickness T of the matrix 24, the D₉₀, and the ratio X.

The conductive resin composition can be prepared by mixing the resin binder (or a raw material thereof) 20 and the conductive filler 22. The conductive resin composition may contain, as necessary, additives such as a dispersant and a solvent, in addition to these.

In the conductive resin layer 10, the matrix 24 is provided in a film-like shape intended to have a predetermined thickness T. In manufacturing the conductive resin layer 10, a person skilled in the art can adjust the thickness of the matrix 24 of the conductive resin layer 10 to be the intended thickness T by a suitable number of experiments, calculations, or the like in accordance with the composition of the conductive resin layer 10 to be used. A conductive filler 22 in which the ratio X of the D₉₀ to the thickness T of the matrix 24 is in a predetermined range is prepared to prepare a conductive resin composition.

The molding method is not particularly limited, and a known film forming method for manufacturing the conductive resin layer 10 having a film-like shape can be used. From the viewpoint of efficiently manufacturing the conductive resin layer 10, for example, a known film forming method can be appropriately used. From the viewpoint of efficiently manufacturing the conductive resin layer 10 that is the film-like body, for example, a molding method such as a casting method with coating, or an extrusion molding method can be adopted.

In a case of adopting the extrusion molding method, the conductive filler 22 is subjected to a thermal load. Therefore, it is preferable to use a metal material such as a metal or an alloy, or a carbon material as the conductive filler 22. In addition, in order to cause the conductive filler 22 to penetrate in the thickness direction against a shearing force during extrusion, a spike-shaped form and a structure-shaped form are suitable. Among these, the conductive filler 22 having a spike-shaped form has an irregular shape to a sphere-shaped form, and has a large number of protrusions having a spiky shape on the surface continuously or aggregated. Therefore, it is advantageous in that it is less likely to cause pinholes against a shearing force during extrusion molding, and it is easy to provide a conductive path in the thickness direction even with a relatively small diameter.

In a case where the collector 4 is composed of the conductive resin layer 10 alone, the collector 4 can be obtained as it is by obtaining the conductive resin layer 10. In addition, in a case where the collector 4 is composed of the conductive resin layer 10 and the metal layer 30, an extrusion lamination method of laminating the conductive resin layer 10 on the metal foil that is the metal layer 30 at the same time as the extrusion molding can be adopted. With the extrusion lamination method, the collector 4 including the conductive resin layer 10 and the metal layer 30 can be efficiently obtained.

In a case where the collector 4 includes the carbon coating layer 32, a composition containing a carbon material, a resin binder, and a dispersion medium such as NMP as necessary can be applied to the metal layer 30 and/or the conductive resin layer 10 and appropriately dried to be imparted.

### Secondary Battery and Manufacturing Method of The Same

The secondary battery disclosed in the present specification is a bipolar secondary battery 100, and can include a bipolar electrode 2 including the collector 4 disclosed in the present specification. With the secondary battery 100, the resistance in the thickness direction is maintained low by using the collector 4. Therefore, a secondary battery 100 advantageous from the viewpoint of cost and battery characteristics is provided.

The secondary battery 100 includes the bipolar electrode 2 in which the negative electrode active material layer 6 is provided on one surface of the collector 4 and the positive electrode active material layer 8 is provided on the other surface. Further, the secondary battery 100 can include the carbon coating layer 32 to face the negative electrode active material layer 6 and/or the positive electrode active material layer 8 of the collector 4, as necessary. In addition, the secondary battery 100 has a structure in which a plurality of the bipolar electrodes 2 are laminated in series through the separator 12.

The secondary battery 100 of this type can be manufactured by a person skilled in the art based on an appropriate known method. The negative electrode active material layer 6, the positive electrode active material layer 8, and the separator 12 are not limited, and known materials can be used for these. According to the present specification, the bipolar electrode 2 including the collector 4 is also provided.

As is clear from the above description, the present specification includes the following aspects.
[1] A collector for a bipolar secondary battery, the collector including a conductive resin layer including a resin binder and a conductive filler, in which the conductive filler has at least one form selected from the group consisting of a spike-shaped form, a structure-shaped form, and a sphere-shaped form, and has a D₉₀ of 1.7 times or more and less than 5.2 times a thickness of a matrix that disperses and holds the conductive filler in the conductive resin layer.
[2] The collector according to [1], in which the conductive filler has a D₉₀ of 2.0 times or more and 5.0 times or less, preferably 2.0 times or more and 4.0 times or less, and preferably 2.0 times or more and 3.0 times or less a thickness of the matrix.
[3] The collector according to [1] or [2], in which the thickness of the matrix is 8 μm or more and 25 μm or less, preferably 8 μm or more and 20 μm or less, and preferably 8 μm or more and 15 μm or less.
[4] The collector according to any one of [1] to [3], in which the D₉₀ of the conductive filler is 16 μm or more and 75 μm or less, preferably 16 μm or more and 60 μm or less, and preferably 16 μm or more and 45 μm or less.
[5] The collector according to any one of [1] to [4], in which the conductive filler has the spike-shaped form or the structure-shaped form.
[6] A bipolar secondary battery including: a bipolar electrode including the collector according to any one of [1] to [5].
[7] A method for manufacturing a collector for a bipolar secondary battery, the method including:
   preparing a conductive resin composition including a resin binder and a conductive filler; and
   molding the collector using the conductive resin composition, preferably by an extrusion molding method,
   in which the conductive filler has a D₉₀ of 1.7 times or more and less than 5.2 times a thickness of a matrix that disperses and holds the conductive filler in a conductive resin layer to be manufactured.
[8] A bipolar electrode including: the collector according to any one of [1] to [5].
[9] A method for manufacturing a bipolar secondary battery using the collector according to any one of [1] to [5].

Hereinafter, Embodiments will be described to more specifically describe the disclosure of the present specification. Therefore, Embodiments below are for describing the disclosure of the present specification and are not intended to limit the scope thereof.

### Embodiment 1

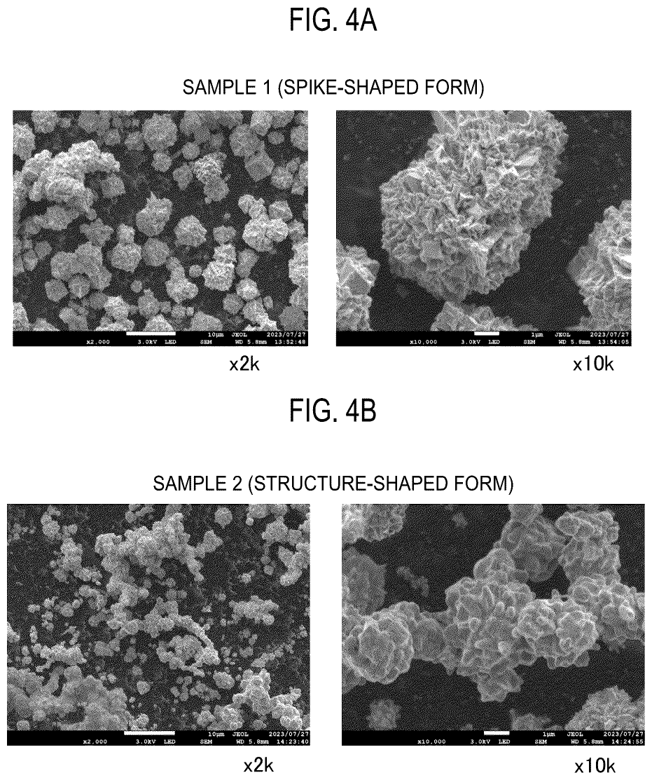

In the present embodiment, various conductive resin compositions were prepared, and a collector in which a conductive resin layer was integrated with an Al foil was produced (samples 1 to 5 and comparative example samples 1 to 10). For these collectors, a resistance value in the penetrating direction was evaluated. As the conductive filler in each of the conductive resin compositions, Ni powder having the form and the particle size distribution shown in Table 1 was used. In addition, as the resin binder, adhesive polypropylene (for extrusion lamination) was used. The resin binder and the conductive filler were put into a twin-screw extruder at a mass ratio of 90:10. The mixture was kneaded at 240° C. to obtain a conductive resin composition. Further, the conductive resin composition was heated to 280° C. with an extrusion lamination device and directly laminated on an Al foil (40 μm thick). FIGS. 4A and 4B show microscope photographs of the Ni powder having a spike-shaped form of the sample 1 and the Ni powder having a structure-shaped form of the sample 2. The particle size distribution of the conductive filler used was determined by measuring a particle size distribution on a volume basis using a laser diffraction/scattering type particle size distribution measuring device.

The crushed materials 1 to 3 were prepared by crushing one kind of Ni powder using a crusher at a predetermined pressure, and the classified materials 1 to 3 were prepared by classifying one kind of Ni powder using a rotary classifier at a predetermined rotation speed.

For these various collectors, a resistance value in the thickness direction of the collector was measured. The resistance value (mΩ) was measured by sandwiching the collector from both sides in the thickness direction with an electrode having a diameter of 20 mm, and the volume resistivity was calculated by multiplying the electrode area and dividing by the film thickness. The thickness T of the matrix of the conductive resin layer was an average value of thicknesses measured at 10 arbitrary points at which the Ni powder was not observed by observing a cross section cut in the thickness direction of the collector using a SEM with EDX. The measurement results are shown together with Table 1. In addition, the appearance of each of the various collectors was observed to evaluate the frequency of occurrence of pinholes (A: excellent, B: good, C: normal, D: defective). The results are shown together with Table 1.

TABLE 1

| | | | | | | | | | | Volume | Pinhole |
|---|---|---|---|---|---|---|---|---|---|---|---|
| | | | Particle Size Distribution μm | | | | | Thickness T | D₉₀/ | Resistivity | Occurrence |
| Category of Sample | | Filler Form | MV | D₁₀ | D₅₀ | D₉₀ | D₉₉ | μm | Thickness T | Ω · cm | Frequency |
| Sample | 1 | Spiky Shape | 11.6 | 4.5 | 10.1 | 21.0 | 36.7 | 10 | 2.1 | 160 | B |
| | 2 | Structural | 19.6 | 3.1 | 18.3 | 38.4 | 58.5 | 10 | 3.8 | 91 | C |
| | | Shape | | | | | | | | | |
| | 3 | Structural | 19.4 | 3.7 | 18.8 | 35.8 | 53.6 | 13 | 2.8 | 133 | C |
| | | Shape | | | | | | | | | |
| | 4 | Structural | 15.9 | 3.7 | 15.0 | 29.4 | 43.9 | 14 | 2.1 | 626 | B |
| | | Shape | | | | | | | | | |
| | 5 | Spherical Shape | 22.5 | 12.1 | 21.4 | 34.6 | 52.1 | 20 | 1.7 | 342 | B |
| Comparative | 1 | Structural | 5.9 | 2.1 | 5.6 | 10.2 | 15.6 | 9.0 | 1.1 | 4273 | B |
| Example | | Shape | | | | | | | | | |
| Sample | 2 | Spherical Shape | 6.4 | 3.1 | 6.2 | 10.1 | 15.2 | 10 | 1.0 | 5388 | B |
| | 3 | Scale Shape | 12.0 | 2.9 | 10.3 | 23.9 | 38.7 | 10 | 2.4 | 2840 | C |
| | 4 | Crushed | 5.5 | 2.1 | 4.8 | 9.4 | 19.0 | 10 | 0.9 | 3164 | A |
| | | Material 1 | | | | | | | | | |
| | | (0.30 MPa) | | | | | | | | | |
| | 5 | Crushed | 4.7 | 2.0 | 4.2 | 7.8 | 15.1 | 9.0 | 0.9 | 9310 | A |
| | | Material 2 | | | | | | | | | |
| | | (0.50 MPa) | | | | | | | | | |
| | 6 | Crushed | 4.2 | 1.9 | 3.8 | 6.8 | 12.7 | 10 | 0.7 | 3141539 | A |
| | | Material 3 | | | | | | | | | |
| | | (0.75 MPa) | | | | | | | | | |
| | 7 | Classified | 7.0 | 2.1 | 5.7 | 13.2 | 28.6 | 11 | 1.2 | 12035 | A |
| | | Material 1 | | | | | | | | | |
| | | (2700 rpm) | | | | | | | | | |
| | 8 | Classified | 4.9 | 1.8 | 3.9 | 8.9 | 20.1 | 9.0 | 1.0 | 6891 | B |
| | | Material 2 | | | | | | | | | |
| | | (3500 rpm) | | | | | | | | | |
| | 9 | Classified | 3.7 | 1.6 | 3.1 | 6.6 | 14.4 | 9.0 | 0.7 | 240796 | B |
| | | Material 3 | | | | | | | | | |
| | | (4000 rpm) | | | | | | | | | |
| | 10 | Material | 24.8 | 3.9 | 20.4 | 41.3 | 60.3 | 8.0 | 5.2 | 188 | D |
| | | Passing 45 μm | | | | | | | | | |
| | | Mesh | | | | | | | | | |

As shown in Table 1, in a case where the filler form was the spike-shaped form, the structure-shaped form, or the sphere-shaped form, it was found that, in a case where D₉₀/thickness T was 1.7 or more, the volume resistivity in the thickness direction was also 1000 or less, and the pinhole occurrence frequency was not a problem (samples 1 to 5). On the other hand, it was found that, in a case where D₉₀/thickness T reached 5.2, even in a case where the volume resistivity was low, pinholes occurred at a high frequency (comparative example sample 10).

In a case where D₉₀/thickness T was small, the volume resistivity increased (comparative example samples 1 to 9). In particular, in a case of the scale-shaped form, even in a case where D₉₀/thickness T was 2.4, the volume resistivity increased (comparative example sample 3).

In particular, it was found that, in a case where the conductive filler had the spike-shaped form and the structure-shaped form, an indicator that D₉₀/thickness T was 2.0 or more was effective.

### Embodiment 2

In the present Example, a monopolar structure coin cell was produced using the collector (samples 1, 2, and comparative example sample 4) prepared in Embodiment 1, and the IV resistance was measured. A ratio of the IV resistance of the bonding foil (collector for a bipolar type in the related art) as a control example is shown in Table 2.

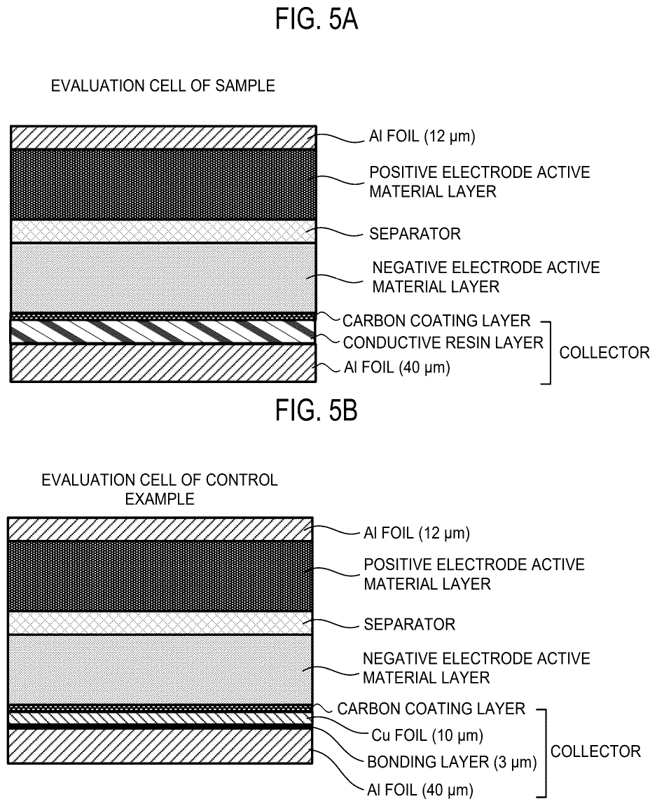

The structure of the cell for evaluation is shown in FIGS. 5A and 5B. A carbon coating layer, a negative electrode active material layer, and a positive electrode active material layer were sequentially provided on the collector with an Al foil prepared in Embodiment 1, and integrated with a separator layer to prepare an evaluation cell. The preparation and formation of each of the layers are shown below.

### Carbon Coating Layer

Acetylene black and PVDF (mass ratio of 90:10) were prepared as a coating liquid having a solid content of 30% with N-methylpyrrolidone (NMP), and applied onto the conductive resin layer side of the collector at a mass of 1 mg/cm² using an applicator and dried.

### Negative Electrode Active Material Layer

Amorphous carbon-coated graphite as an active material, carboxymethyl cellulose (CMC) as a thickener, and styrene butadiene rubber (SBR) as a binder were mixed at a mass ratio of 97:0.7:2.3 to prepare a negative electrode paste. The prepared negative electrode paste was applied onto the carbon coating layer at a mass of 22.6 mg/cm² using an applicator, dried, and roll-pressed to provide a negative electrode layer having a predetermined negative electrode density (1.2 g/cm²).

### Positive Electrode Active Material Layer

As an active material, nickel cobalt manganese lithium (NCM), acetylene black as a conductive auxiliary agent, and PVDF as a binder were mixed at a mass ratio of 95:2.5:2.5 to prepare a positive electrode paste. The Al foil (12 μm thick) application of the prepared positive electrode paste was performed onto the carbon coating layer at a mass of 38 mg/cm² using an applicator, dried, and roll-pressed to provide a positive electrode layer having a predetermined positive electrode density (3.0 g/cm²).

In the control example, a Cu foil (10 μm) was integrated with an Al foil (40 μm thick) through a bonding layer (3 μm), and a carbon coating layer was provided on the surface of the Cu foil, except for this, the preparation was performed in the same manner as described above.

TABLE 2

| | | | | | | Volume | Pinhole | IV |
|---|---|---|---|---|---|---|---|---|
| | | | D₉₀ | Thickness T | D₉₀/ | Resistivity | Occurrence | Resistance |
| Category of Sample | | Filler Form | μm | μm | Thickness T | Ω · cm | Frequency | Ratio |
| Sample | 1 | Spiky Shape | 21.0 | 10 | 2.1 | 160 | B | 98% |
| | 2 | Structural | 38.4 | 10 | 3.8 | 91 | C | 101% |
| | | Shape | | | | | | |
| Comparative | 4 | Crushed | 9.4 | 10 | 0.9 | 3164 | A | 423% |
| Example | | Material 1 | | | | | | |
| Sample | | (0.30 MPa) | | | | | | |

As shown in Table 2, in the cells using the collectors of the samples 1, 2, the IV resistance ratio was the same as in a case where the bonding foil was used. On the other hand, in the cell using the collector of the comparative example sample 4, the IV resistance ratio was significantly deteriorated.

From these findings, it was found that, in a case where the conductive filler was used in the conductive resin layer and the collector in which D₉₀/thickness T was controlled, the resistance in the thickness direction could be maintained low, and as a result, the resistance could be maintained low even in a case of providing a secondary battery.

What is claimed is:

1. A collector for a bipolar secondary battery, the collector comprising:
a conductive filler; and
a resin binder,
wherein the conductive filler has at least one form selected from the group consisting of a spike-shaped form, a structure-shaped form, and a sphere-shaped form, and has D₉₀ with 1.7 times or more and less than 5.2 times a thickness of a matrix that disperses and holds the conductive filler in the collector.

2. The collector according to claim 1, wherein the conductive filler has D₉₀ with 2.0 times or more and 5.0 times or less the thickness of the matrix.

3. The collector according to claim 1, wherein the thickness of the matrix is 8 μm or more and 25 μm or less.

4. The collector according to claim 3, wherein the D₉₀ of the conductive filler is 16 μm or more and 75 μm or less.

5. The collector according to claim 1, wherein the conductive filler has the spike-shaped form or the structure-shaped form.

6. A bipolar secondary battery comprising a bipolar electrode including the collector according to claim 1.
